(19) United States
(12) Patent Application Publication
(10) Pub. No.: US 2003/0123043 A1
(43) Pub. Date: Jul. 3, 2003

(54) Film adapter for film scanner

(75) Inventor: Yuichi Kurosawa, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/327,953

(22) Filed: Dec. 26, 2002

(30) Foreign Application Priority Data
Dec. 27, 2001 (JP) P2001-396821

(51) Int. Cl. G03B 27/58

(52) U.S. Cl. 355/72

(57) ABSTRACT

A film adapter for a film scanner is provided. The film adapter is loaded with a cartridge containing a film having a magnetic recording layer. The adapter is used to position a frame image at a scanning position by winding out the film from the cartridge. The film adapter comprises a magnetic head, a film transfer mechanism, and a magnetic head contact-noncontact mechanism. The magnetic head detects information from the magnetic recording layer. The film transfer mechanism controls the transfer operation of the film. The magnetic head contact-noncontact mechanism separates the magnetic head from the magnetic recording layer in accordance with the transfer operation so that the time the head is in contact with the magnetic recording layer is reduced.

### BACKGROUND OF THE INVENTION

1. Field of the Invention

The present invention relates to a film scanner that converts an image produced on a film into corresponding electric image signals by using photoelectric conversion elements. Particularly, the invention relates to a film adapter that is utilized for scanning a film contained in a cartridge.

2. Description of the Related Art

With the spread of personal computers in recent years, images that are taken by a digital still camera or scanned by a scanner are often processed by computers and are stored in them. To keep up with these changes in technology, a film scanner is proposed that enables a computer to input images produced on a photographing film such as a silver halide film. For this type of film scanner, a film adapter for loading a cartridge onto the film scanner is proposed so that a film contained in a cartridge, such as an APS (Advanced Photo System) film, can be scanned.

For example, an adapter for an APS film houses a cartridge that contains an APS film. The APS film is wound off or rewound inside the cartridge by a drive motor so that a frame image is positioned on a frame window that is formed on the adapter to expose the image outside the cartridge. Thereby, a frame image of the APS film that is exposed at the frame window can be read by scanning the image with an imaging device. Further, to read another frame image, the APS film is wound off or rewound inside the APS film adapter so that the objective frame is exposed through the frame window.

### SUMMARY OF THE INVENTION

In a scanner utilized with an APS film adapter, an accumulation period for the CCD (imaging device) in a scanning operation is determined with reference to photographing information on an APS film. Namely, the photographing information which is recorded on the magnetic recording layer of the APS film is read by a magnetic head. Thereby, the magnetic recording layer of the APS film is kept in contact with the magnetic head for reading the information from the film and this contact is maintained even when the magnetic head is not reading the information. However, the sliding contact between the magnetic head and the magnetic recording layer causes abrasion or wear on the surface of the magnetic recording layer and produces magnetic dust or powder due to the abrasion. The magnetic dust may cling to the magnetic head or magnetize the magnetic head itself, causing the reading characteristics of the magnetic head to deteriorate.

Therefore, an object of the present invention is to provide a film adapter for a film scanner that is able to prevent deterioration of the reading characteristics of a magnetic head of the film adapter.

According to the present invention, a film adapter is provided for a film scanner that detects a frame image produced on a film as electric signals by an imaging device. The film adapter is loaded with a cartridge containing a film having a magnetic recording layer, and is used to position a frame image at a scanning position of the imaging device by paying out film from the cartridge. The film adapter comprises a magnetic head, a film transfer mechanism, and a magnetic head contact-noncontact mechanism.

The magnetic head detects information recorded on the magnetic recording layer. The film transfer mechanism controls a transfer operation of the film. The magnetic head contact-noncontact mechanism separates the magnetic head from the magnetic recording layer in accordance with the transfer operation.

### BRIEF DESCRIPTION OF THE DRAWINGS

The objects and advantages of the present invention will be better understood from the following description, with reference to the accompanying drawings in which:

FIG. 1 is a schematic perspective view showing a film scanner of an embodiment of the present invention;

FIG. 2 schematically illustrates a sectional front view of the film scanner shown in FIG. 1;

FIG. 3 shows a partially exploded perspective of a film adapter;

FIG. 4 schematically illustrates a perspective of a film transfer mechanism;

FIG. 5 schematically illustrates a perspective of a magnetic head contact-noncontact mechanism;

FIG. 6A is a partially enlarged side view of the magnetic head contact-noncontact mechanism;

FIG. 6B is a partially enlarged front view of the magnetic head contact-noncontact mechanism;

FIG. 7 is a block diagram that shows an electrical construction of the film scanner; and

FIGS. 8A and 8B show movement of the magnetic head contact-noncontact mechanism.

### DESCRIPTION OF THE PREFERRED EMBODIMENTS

The present invention is described below with reference to the embodiments shown in the drawings.

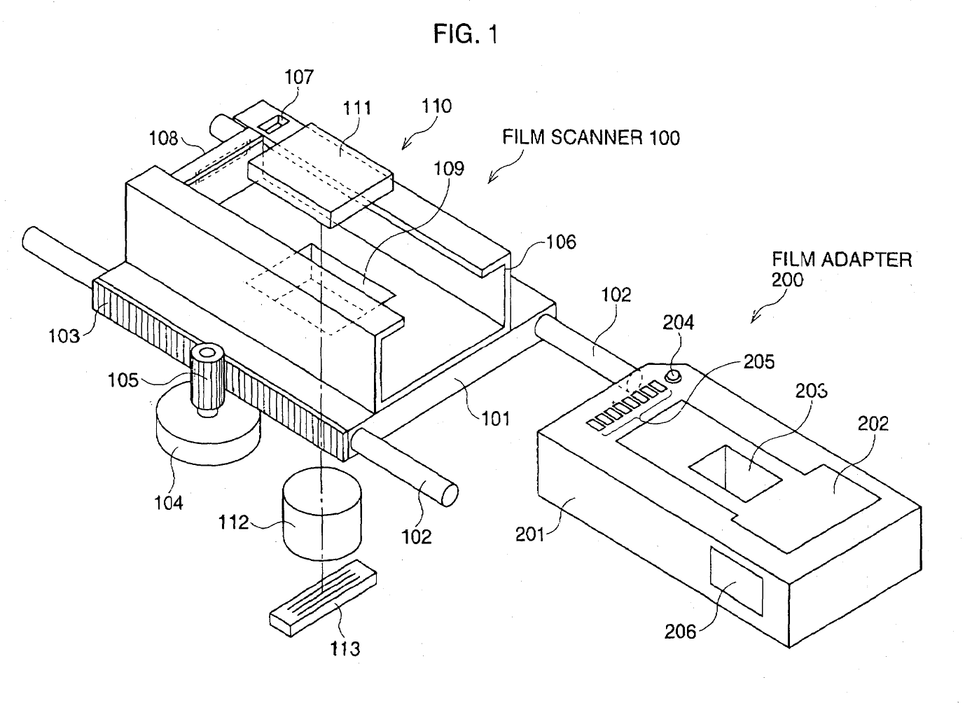

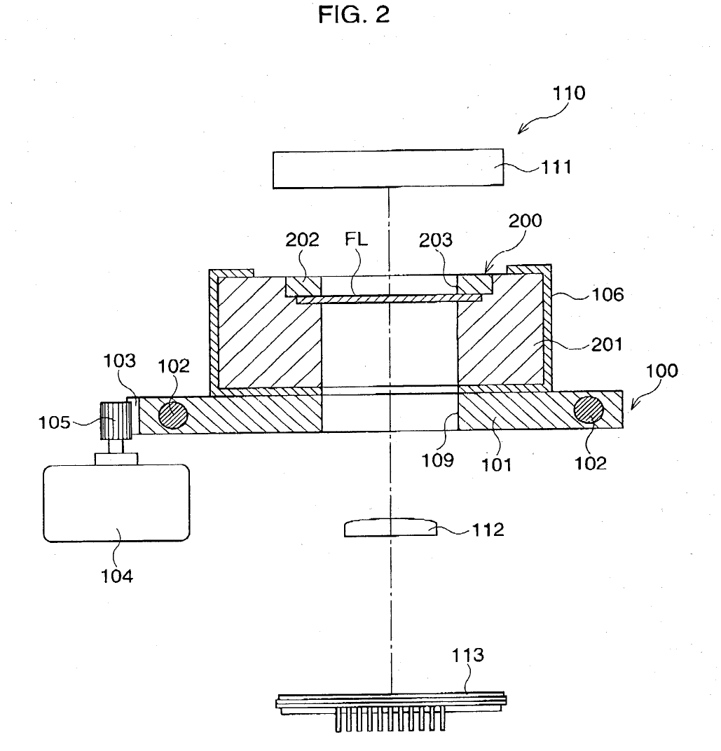

FIG. 1 schematically illustrates a perspective view of a conceptual structure of the present embodiment. This includes a film scanner utilizing an APS film adapter to which the present invention is applied. Further, FIG. 2 schematically illustrates a front cross-sectional view of the apparatus shown in FIG. 1 Two guide bars 102 in the figures are bridged horizontally onto the casing (not shown) of the film scanner 100. Further a moving table 101 bridges these two guide bars 102. Namely, each guide bar 102 penetrates each side of the moving table 101 so that the moving table 101 reciprocally slidable along the guide bars 102. A rack 103 is formed on a side of the moving table 101 in the direction to which the moving table is translated. The rack 103 engages with a pinion 105 that is attached to the rotating axis of a scanning motor 104 An example of the scanning motor 104 is a stepping motor which is disposed inside the casing. The moving table 101 is reciprocally translatable along the guide bars 102 due to the engagement between the pinion 105 and the rack 103 when the scanning motor 104 is rotatably driven.

A holder 106 for holding the APS film adapter 200 (the details of the adapter will be described later) is integrally formed on the upper surface of the moving table 101 The holder 106 generally has an upended gatelike shape and each end of the gate has a flange which extends inward. So that the holder 106 is formed in such manner that the APS film adapter 200 can be inserted into it from one side and supported. The holder 106 has an engagement hole 107 and electric terminals 108 The engagement hole 107 engages with a latch bolt or a click spring 204 which is attached to the APS film adapter 200, thereby the supporting position of the APS film adapter 200 is determined. The electrical terminals 108 contact with the electrical terminals 205 of the APS film adapter 200. Further, a rectangular window 109 is formed in the moving table 101 for exposing a frame image to be read, and an image-reading member 110 for reading the frame image is provided in a position in which the image-reading member 110 faces the window 109.

The image-reading member 110 comprises a diffuse light source 111, an imaging lens 112, and a CCD line sensor 113. The diffuse light source 111 is disposed above the moving table 101. The imaging lens 112 is disposed below the moving table 101 and right under the diffused light source 111. The CCD line sensor 113 scans an image of a film image formed by the imaging lens 112 and converts the image to electric signals by means of photoelectrical conversion. The CCD line sensor 113 of the present embodiment may be a color-image adapted line-sensor unit that includes a plurality of monochrome CCD line sensors. For example, the unit includes three monochrome CCD line sensors and each corresponds to a color R (Red), G (Green), and B (Blue). The monochrome CCD line sensors are arranged in parallel along the line that transverses the direction to which the moving table 101 is moved. Namely, in the present embodiment, the CCD line sensor 113 is aligned perpendicular to the moving direction of the moving table 101, so that the main-scanning of a film is carried out along the alignment of the CCD line sensor 113 and the sub-scanning is carried out by translation of the moving table 101.

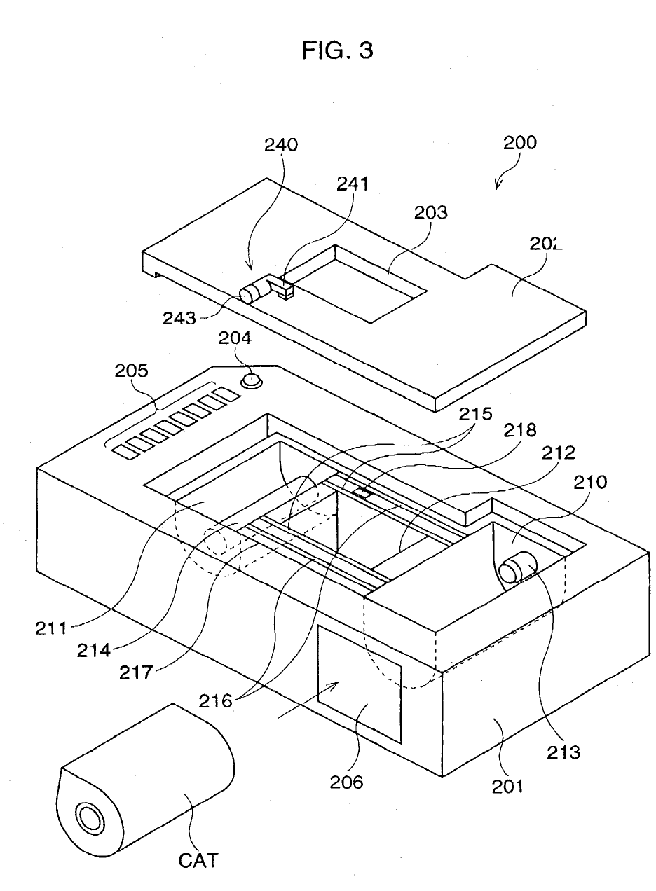

The casing of the APS film adapter 200 is formed as compressed cuboids so that the APS film adapter 200 can be slid into the holder 106 and supported thereby. The APS film adapter 200 comprises the adapter body 201 and a cover plate 202. About the center of the cover plate 202, a rectangular frame window 203 is provided that faces the window 109 when the APS film adapter 200 is properly positioned in the holder 106, so that a frame image of an APS film is exposed through the frame window 203 Further, is the latch bolt or click spring 204, which engages with the engagement hole 107 of the holder 106 and which has hemispheric outline, is provided on the edge of the upper surface of the APS film adapter 200 and is biased upward. The electric terminals 205, which will engage with the electric terminal 108 of the holder 106, is provided beside the click spring 204. Further, as shown in FIG. 3, on a side surface of the APS film adapter 200, a cartridge cover 206 that shields an opening through which an APS cartridge ‘CAT’ is loaded or unloaded, is attached.

FIG. 3 is a perspective view showing the inside of the adapter body 201 with the cover plate 202 of the APS film adapter 200 removed. Inside the adapter body 201, a cartridge room 210 is arranged at the position which corresponds to the cartridge cover 206, and at the opposite side to the cartridge room 210, a spool room 211 is arranged. Further, an aperture 212 that faces the frame window 203 is disposed adjacent to the window 203 and between the cartridge room 210 and the spool room 211 Inside the cartridge room 210, a fork block 213 engages with the APS cartridge ‘CAT’ for winding off and then rewinding the APS film. Further, inside the spool room 211, a spool 214 for winding the APS film, which is wound out from the APS film cartridge ‘CAT’, is arranged. On each side of the aperture 212, a pair of inner rails 215 and outer rails 216 is laid along the direction in which the APS film is moved. The inner rails 215 are made positioned so as to come into contact with the emulsion side of the APS film and, in doing so define the position of the emulsion surface. The outer rails 216 come into contact with the back surface of the cover plate 202 and form a space or a tunnel between the inner rails 215 and the cover plate 202, so that an APS film is transferred inside the tunnel.

Between the inner rail 215 and the outer rail 216, which is arranged on a certain side (back side in the figure), a photo-interrupter 218 is provided that detects perforations of an APS film and determines a position of the film to be transferred. Further, on the other side (front side in the figure) of the adapter body 201, an opening 217 is formed so that the inside and outside of the adapter body 201 are interconnected. A toothed belt 230 of a film transfer mechanism (which will be described in detail later) is arranged so as to face the opening 217, thereby a part of the toothed belt 230 can be seen through the opening 217.

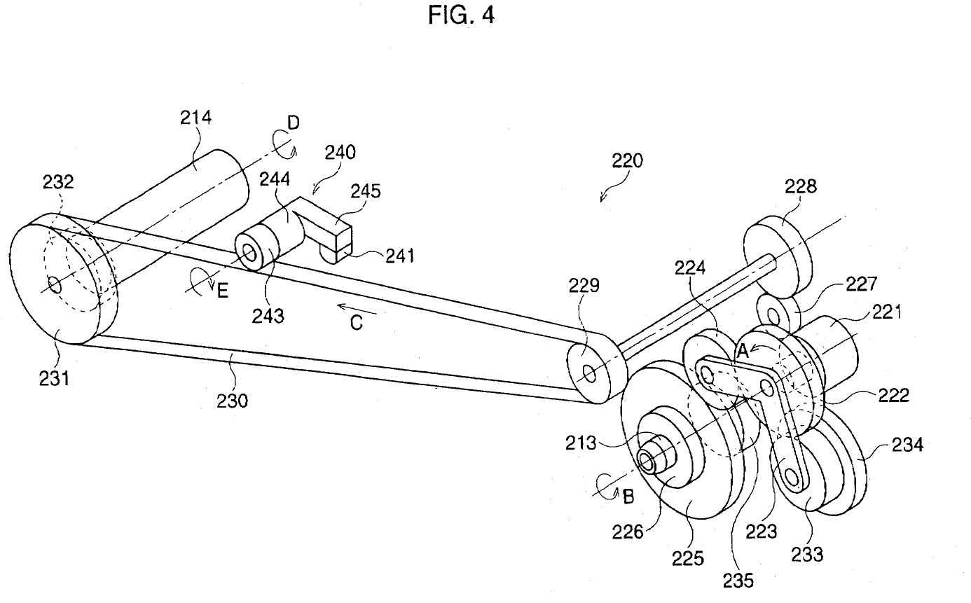

FIG. 4 is a perspective view showing the concept of the film transfer mechanism 220 which includes the fork block 213 and the spool 214. Note that, a magnetic head contact-noncontact mechanism 240, which will be described later, is also illustrated in the figure The film transfer mechanism 220 is comprised of a belt drive system and a gear train that is driven by a motor 221 The construction of the film transfer mechanism 220 and its action will be explained in the following. For winding out or winding off a film, the gear 222 is rotated in the direction ‘A’ by the motor 221 The drive power is transmitted to the fork block 213 through a gear 224 which is supported by an arm 223, a gear 225, and through a one-way clutch 226, so that the fork block 213 is rotated in the direction ‘B’. Accordingly, the film, stored inside the APS film cartridge ‘CAT’, is wound out and transferred toward the spool room 211 with film guided between the inner rails 215 and the outer rails 216. Simultaneously, the gear 222 rotates according to the rotation of the motor 221 in the direction ‘A’ and this rotation is transmitted to the toothed belt 230 via gears 227, 228, and a gear 229 on which the toothed belt 230 is trained around, so that the toothed belt 230 is moved or rotated in the direction ‘C’. The toothed belt 230 is also trained around a gear 231, so that the spool 214 is rotated in the direction ‘D’ through the gear 231 and a one-way clutch 232 which is arranged between the gear 230 and the spool 214. Note that, the amount of film wound by the rotation of the spool 214 is larger than the amount of a film paid out from the APS film cartridge ‘CAT’. Therefore, when the film which is paid out from the APS film cartridge by the rotation of the fork block 226 reaches the spool 214, and the film winding operation of the spool 214 starts, the drive power transmission from the motor 221 to the fork block 213 is disconnected by the one-way clutch 226 which is arranged between the gear 225 and the fork block 213. Accordingly, the fork block 213 is rotated by the film wound by the spool 214.

For rewinding a film, the motor 221 rotates the gear 222 in the opposite direction with respect to the direction ‘A’. In this case, the drive power of the gear 222 is transmitted to the fork block 213 through gears 233, 234, and 235 which are supported by the arm 223, and further through the gear 225 and the one-way clutch 226, so that the fork block 213 is rotated in the opposite direction with respect to the direction ‘B’ and the film is rewound into the APS film cartridge ‘CAT’. During the rewinding operation, also the belt drive system is inversely driven and the reversed rotation power is transmitted to the one-way clutch 232 via the gears 222, 227, 228, 229, toothed belt 230, and gear 231. However, the one-way clutch 232 forbids the reversed rotation power transmission, so that the power for rotating the spool 214 in the opposite direction with respect to the direction ‘D’ can not be transmitted to the spool 214. Therefore, the spool 214 is rotated by the film that is rewound by the fork block 213. Note that, a part of the toothed belt 230 is exposed to the outside of the adapter body 201 through the opening 217 formed on the adapter body 201.

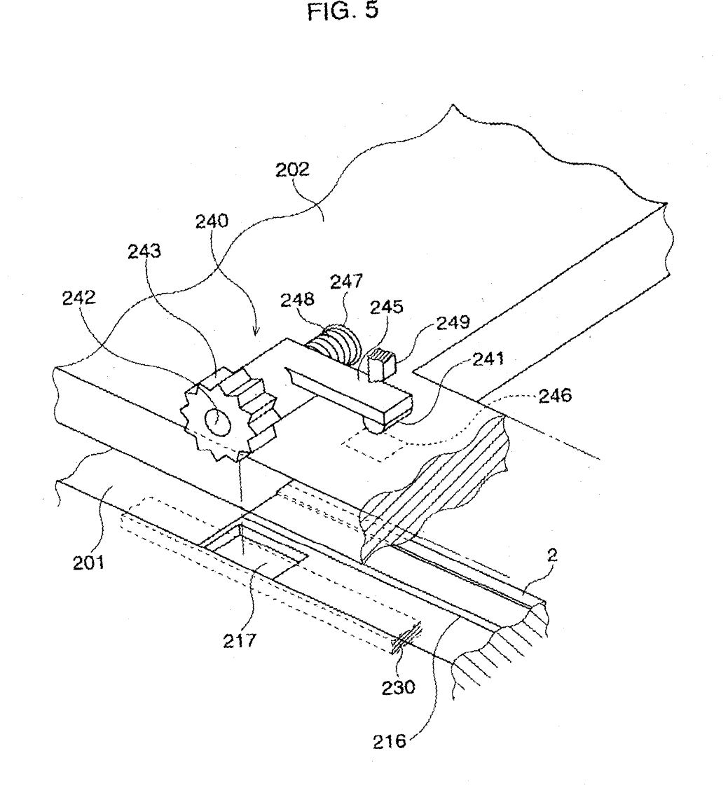

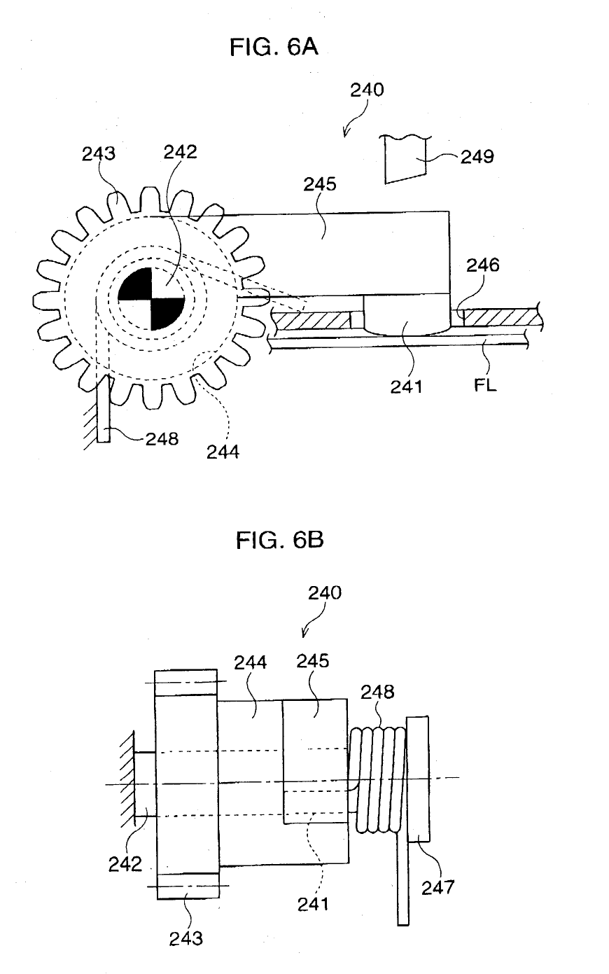

On the other hand, on the cover plate 202, the magnetic head contact-noncontact mechanism 240 is provided. The magnetic head contact-noncontact mechanism 240 engages with the toothed belt 230 through the opening 217 and receives the drive power to displace the magnetic head 241. FIG. 5 is the enlarged partial perspective view of the magnetic head contact-noncontact mechanism 240 and FIGS. 6A and 6B are respectively a fragmented side view and a front view thereof. As shown in FIG. 5 and FIGS. 6A and 6B, the magnetic head contact-noncontact mechanism 240 has a short fixed axle 242 arranged in parallel with the spool 214. A small gear 243 that engages with the toothed belt 230 through the opening 217 is rotatably attached to the fixed axle 242. Further, a short cylindrical boss 244 that is integrally formed with a head-supporting arm 245 is coaxially aligned with the small gear 243, side-by-side, and rotatably fixed to the fixed axle 242. Namely, the side of the small gear 243 and the side of the boss 244 that face each other in the axial direction come into contact with one another directly. The head-supporting arm 245 extends from the boss 244 along a line tangent to the boss 244 at a required length. At the end of the head-supporting arm 245, the magnetic head 241 is supported with its recording surface facing downward. It is structured so as the magnetic head 241 is able to come into contact with the magnetic recording layer on the backside surface of the APS film (which is loaded into the adapter body 201 and transferred over the aperture 212) when the magnetic head sticks out or protrudes from a head opening 246 that is formed on the cover plate 202.

Further, at the end of the fixed axle 242 of the magnetic head contact-noncontact mechanism, a flange 247 is integrally formed. A coil shaped compressed torsion spring 248 is mounted between the flange 247 and the side of the head-supporting arm 245. One end of the compressed torsion spring 248 is fixed to a fixing member (not shown in detail) and the other end is engaged with the head-supporting arm 245, so that the head-supporting arm 245 is given a rotational spring force in the counter clock wise direction with respect to FIG. 6A. Consequently, the magnetic head 241 is supported at an upper position where the magnetic head 241 is apart from the magnetic recording layer of an APS film. Further, the compressed torsion spring 248 compresses the boss 244 toward the small gear 243 and keeps them in contact with each other. Note that, a stopper 249 that limits the counter clock wise rotation of the head-supporting arm 245 by the torsion spring 248 is disposed above the head-supporting arm 245. The small gear 243 of the magnetic head contact-noncontact mechanism 240 on the cover plate 202 engages with the toothed belt 230 of the film transfer mechanism 220 through the opening 217 of the adapter body 201 when the cover plate 202 is put on the adapter body 201. At the same time, the head opening 246 of the cover plate 202 is positioned between the inner rail 215 and the outer rail 216, so that the magnetic head 241 is able to come into contact with the magnetic recording layer formed on the backside of the APS film ‘FL’ when it protrudes out from tho head opening 246.

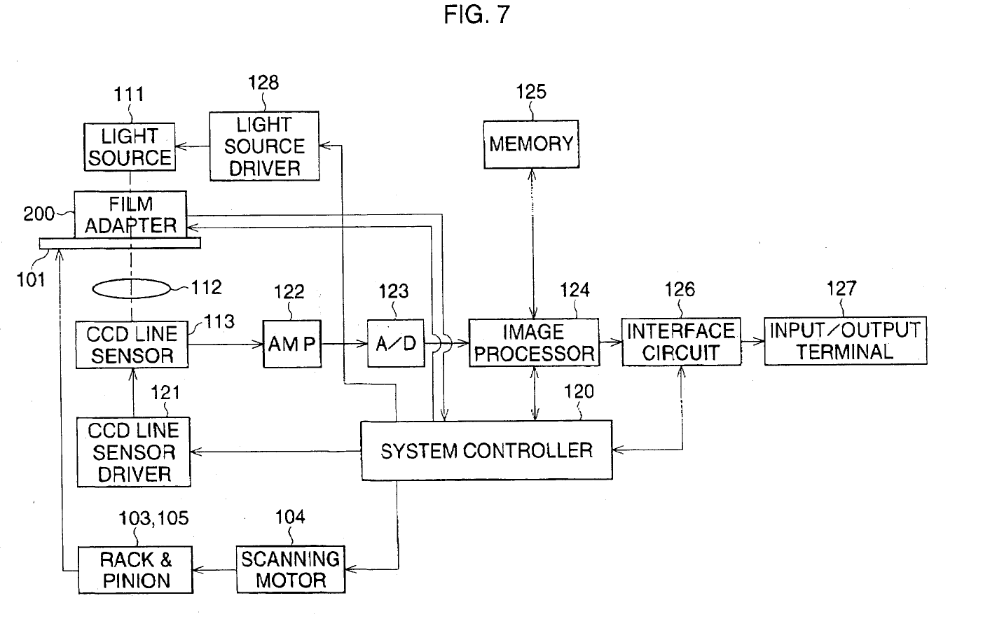

The electric block diagram of the film scanner 100 is shown in FIG. 7. The same numerals are used to indicate the same members illustrated in FIGS. 1 to 6. The CCD line sensor 113 is driven by a CCD line sensor driver 121 which is controlled by a system controller 120. Image signals that are detected from a film and output from the CCD line sensor 113 are amplified by an amplifier 122 and converted to digital signals by an A/D converter 123. Any kind of image processing that is required is then performed on the digital image signals by the image processor 124 and corrected image signals are produced. A memory 125 is for storing the image signals that have already undergone the above image processing, and may comprise an IC card. Further, the image signals are also output to an input/output terminal 127 via an interface circuit 126 and then fed to an external device or devices that are not shown; e.g. a personal computer. Emission of the light source 111 is controlled by a light source driver 128 which is controlled by the system controller 120. Further, electric power is supplied to the APS film adapter 200 through an electric contact that comprise the electric terminals 205 and 108, so that the film transfer mechanism 220 and the magnetic head contact-noncontact mechanism 240 are controlled by the system controller 120.

An outline of the scanning operations of the film scanner with the above construction will be explained in the following. An APS film cartridge ‘CAT’ (inside which an APS film ‘FL’ with images to be read is contained) is installed into the APS film adapter 200. Then the APS film adapter 200 is inserted into the holder 106 of the moving table 101. When the APS film adapter 200 is slid to the predetermined position, the click spring 204 fits into the engagement hole 107 and the adapter 200 is positioned properly. At the same time, the electric terminals 205 come into contact with the electric terminals 108. Thereby the APS film adapter 200 is electrically connected to the system controller 120, so that electric power can be supplied to the motor 221 of the film transfer mechanism 220. Further, information read by the magnetic head 241 can be fed to the system controller 120. In the APS film adapter 200, a required frame image is positioned at the aperture 212 and exposed through the frame window 203 after the motor 221 of the film transfer mechanism 220 has been driven to wind out the APS film ‘FL’ from the APS film cartridge ‘CAT’ and to wind it on the spool 214. Then the light source 111 is turned on and after performing a predetermined process (e.g. a shading correction) for the frame image, the main scanning is started for the frame image via the imaging lens 112 by the CCD line sensor 113. Simultaneously, the scanning motor 104 is driven and the sub-scanning is started. Namely, the APS film adapter 200 is translated along the guide bars 102 with the moving table 101. Accordingly, the image reading operation for the frame image of the APS film ‘FL’ is carried out.

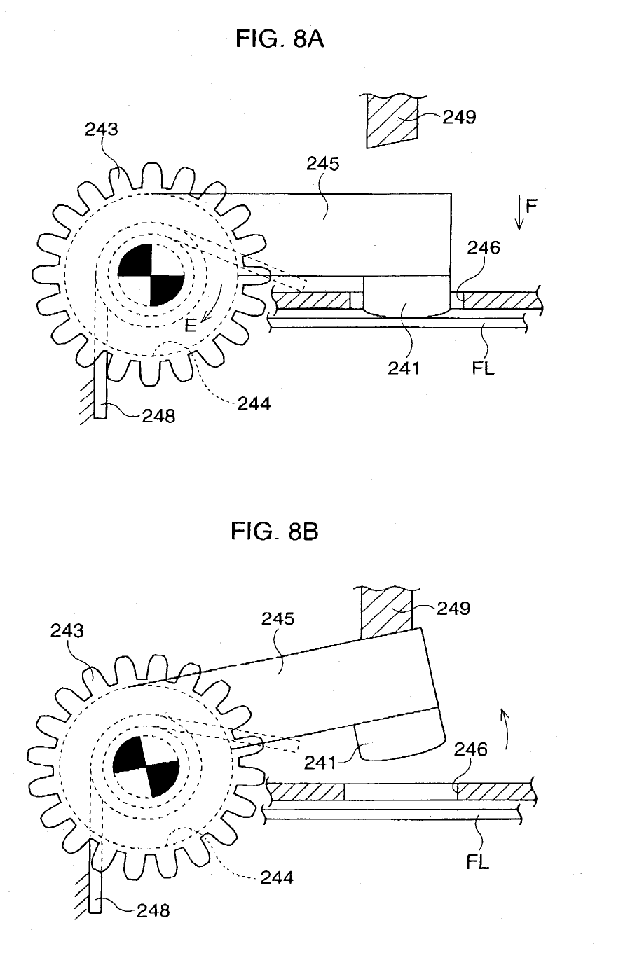

The winding out or rewinding operations for the APS film ‘FL’ inside the APS film adapter 200 during the above scanning operation are performed by the operation of the film transfer mechanism 220 which is controlled by the motor 221 driven in the above described manner. At this time, as shown in FIG. 4, the toothed belt 230 is moved to the direction ‘C’ when the APS film ‘FL’ is paid out from the APS film cartridge ‘CAT’, so that the small gear 243 of the magnetic head contact-noncontact mechanism 240 which engages the toothed belt 230, is rotated in the ‘E’ direction. The revolution power is transmitted to the head-supporting arm 245 by the frictional contact between the small gear 243 and the boss 244 of the head-supporting arm 245. Thereby, as shown in FIG. 8A, the head-supporting arm 245 is rotated in the direction ‘F’ against the spring force of the compressed torsion spring 248, so that the head-supporting arm 241 is moved downward and contacts the magnetic recording layer of the APS film ‘FL’. Namely, information in the magnetic recording layer is read by the magnetic head 241.

On the other hand, when the APS film ‘FL’ is rewound into the APS film cartridge ‘CAT’, the toothed belt 230 is moved oppositely to the direction ‘C’ by the counter wise rotation of the motor 221, so that the small gear 243 of the magnetic head contact-noncontact mechanism 240 is rotated in the direction opposite to the direction ‘E’. The revolution power is transmitted to the boss 244 of the head-supporting arm 245 from the small gear 243. As a result, the head-supporting arm 245 is rotated in the direction opposite to the direction ‘F’ by the torsion spring force of the compressed torsion spring 248 and the head-supporting arm 245 is lifted until it contacts the stopper 249. Accordingly, the magnetic head 241 is moved away from the magnetic recording layer of the APS film ‘FL’ and is released from the sliding contact with the magnetic recording layer. At this time, the frictional force due to the contact between the small gear 243 and the boss 244 of the head-supporting arm 245 is reduced since the compressed torsion spring 248 is loosend by the rotations of the small gear 243 and the head-supporting arm 245 in the directions opposite to ‘E’ and ‘F’ respectivly. Therefore, the transmission of the revolution power from the small gear 243 to the head-supporting arm 245 is interrupted while the small gear 243 is being revolved by the toothed belt 230, so that movement of the toothed belt 230 is not obstructed Further, as shown in FIG. 8B, even while the APS film is not being wound out or rewound, or while the film is at rest, the head-supporting arm 245 is also lifted up to the position where it contacts the stopper 249 since there exists a backlash between the teeth of the small gear 243 and the toothed belt 230 so that the head-supporting arm 245 is rotated in the direction opposite to the direction ‘F’ by the spring force of the compressed torsion spring 248.

As described above, according to the APS film adapter 200 of the present embodiment, the magnetic head 241 comes into contact with the magnetic recording layer only when the APS film ‘FL’ is paid out from the APS film cartridge ‘CAT’. Information recorded on the magnetic recording layer for each frame image photographed on the APS film is detected by the magnetic head 241 only on that occasion and may be fed to the system controller 120. On the other hand, in order to rewind the APS film ‘FL’ into the APS film cartridge ‘CAT’, the magnetic head 241 is positioned separate from the APS film so that the contact between the magnetic head 241 and magnetic recording layer is released As a result, the magnetic dust or powder generated due to the sliding contact between the magnetic head 241 and the magnetic recording layer can be suppressed. Therefore, magnetization of the magnetic head is prevented so that effective and proper reading is maintained. Therfore the magnetic head can detect normal or proper information at all times. Particularly, when the conventional APS film adapter is operated in a manner including the following steps—first, all of the APS film ‘FL’ is wound out from the APS film cartridge ‘CAT’ to read information for each frame image; second, rewinding the APS film into the APS film cartridge; third, positioning a required frame image at the frame window 203 by winding out. the APS film from the APS film cartridge in accordance with the above detected information—the magnetic recording layer and the magnetic head are kept in contact all through the operation and the magnetic head slides on the magnetic recording layer during the operation. Therefore, it is quite effective for restraining the problems of magnetic dust and magnetization of the magnetic head when the APS film adapter 200 of the present embodiment is applied to the operations described above.

Further, in the structure of the present embodiment, the revolution power from the toothed belt of the film transfer mechanism is used to drive the mechanism for separating the magnetic head from the magnetic recording layer of the APS film, so that an exclusive mechanism for separating the magnetic head is not required. Therefore, it is quite effective for simplifying the structure and reducing cost. Note that, when cost reduction is not required, the film adapter may be structured to draw apart the magnetic head from the magnetic recording layer by an exclusive mechanism that has a separate individual drive power.

In the present embodiment, the invention is applied to the APS film, however, the invention can be applied to any type of cartridge that contains a rolled film with a magnetic recording layer as well.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2001-396821 (filed on Dec. 27, 2001) which is expressly incorporated herein, by reference, in its entirety.

1. A film adapter for a film scanner that detects a frame image produced on a film as electric signals by using an imaging device, said film adapter is loaded with a cartridge containing said film having a magnetic recording layer, and said film adapter is used to position said frame image at a scanning position of said imaging device by winding out said film from said cartridge, wherein said film adapter comprises:
a magnetic head that detects information recorded on said magnetic recording layer;
a film transfer mechanism that controls a transfer operation of said film; and
a magnetic head contact-noncontact mechanism that separates said magnetic head from said magnetic recording layer in accordance with said transfer operation.

2. A film adapter according to claim 1, wherein said magnetic head contact-noncontact mechanism comprises:
a rotatable member that is rotated by drive power from said film transfer mechanism in accordance with said winding out operation and a rewinding operation for said film, from said cartridge;
a magnetic head-holding mechanism that keeps said magnetic head in contact with said magnetic recording layer when said rotatable member is rotated in one directions and moves said magnetic head away from said magnetic recording layer when said rotatable member is rotated in an opposite direction to said one direction; and
an engagement mechanism that is able to rotate said rotatable member together with said magnetic head-holding mechanism when said rotatable member is rotated in said one direction, and said magnetic head-holding mechanism rotates independently of said rotatable member when said rotatable member is rotated in said opposite direction.

3. A film adapter according to claim 2, wherein said magnetic head contact-noncontact mechanism further comprises a compressed torsion spring for which the compression states alter depending on the rotational direction of said rotatable member;
wherein said rotatable member and said magnetic head-holding mechanism are arranged side by side along the axis of said rotational member and contact each other, said engagement mechanism forces said magnetic head-holding mechanism and said rotatable member to connect with each other in a direction of said axis, by the force of said compressed torsion spring.

4. A film adapter according to claim 1, further comprised of an adapter body and a cover member, wherein said film transfer mechanism is arranged inside said adapter body, said magnetic head contact-noncontact mechanism is arranged on said cover member, and said magnetic head is able to contact with and separate from said magnetic recording layer formed on the backside of said film.

5. A film adapter according to claim 2, said film transfer mechanism comprises:
a motor that generates drive power for said film transfer mechanism;
a fork block that engages with said cartridge for said winding out and rewinding operations of said film;
a spool that engages with the end of said film to wind and rewind said film; and
a gear train and a belt drive system that cooperatively drive said fork block and said spool by using said drive power of said motor;
wherein the drive power for said magnetic head contact-noncontact mechanism is supplied via said belt drive system.

6. A film adapter according to claim 5, wherein said belt drive system comprises a toothed belt, and said rotatable member comprises a gear that engages with said toothed belt and rotates according to a movement of said toothed belt.

7. A film adapter according to claim 1, wherein said film comprises an APS film and said cartridge comprises an APS film cartridge.
